(19) United States
(12) Patent Application Publication
(10) Pub. No.: US 2017/0039196 A1
(43) Pub. Date: Feb. 9, 2017

(54) COMPUTING SYSTEM TO EVALUATE SENTIMENT OF ENTITIES BY PROCESSING DATA

(71) Applicant: Ariba, Inc., Walldorf (DE)

(72) Inventor: Debashis Banerjee, Bangalore (IN)

(21) Appl. No.: 14/862,971

(22) Filed: Sep. 23, 2015

(30) Foreign Application Priority Data
Aug. 6, 2015 (IN) 4104/CHE/2015

(51) Int. Cl. G06F 17/30

(52) U.S. Cl. CPC G06F 17/3053; G06F 17/30554; G06F 17/30867

(57) ABSTRACT

In sentiment evaluation in procurement and auctions, keywords associated with sentiments of an entity are dynamically extracted from sources. Based on the extracted keywords, weighted sentiment indicators of the entity are calculated based on corresponding weights associated with the sources and corresponding sentiment indicators of the keywords in the server system. A weighted sentiment value of the entity is dynamically calculated based on weighted sentiment indicators of the entity in a server system. The weighted sentiment value of the entity is mapped to a sentiment representation in the server system. The sentiment representation is received in a frontend application system from the server system. The frontend application system communicates with the server system via application program interfaces. The sentiment representation of the entity is displayed in a graphical user interface as a result of sentiment evaluation of the entity.

The present application claims the priority benefit of the filing date of Indian Provisional Application No.: 4104/CHE/2015, filed Aug. 6, 2015, entitled “COMPUTING SYSTEM TO EVALUATE SENTIMENT OF ENTITIES BY PROCESSING DATA”.

### FIELD

Embodiments of the invention generally relate to data processing, and more particularly to computing system to evaluate sentiment of entities by processing data.

### BACKGROUND

Enterprises provide procurement applications where buyers procure goods and services from supplier organizations. Procurement involves managing buying decisions based on various factors associated with the supplier organizations and buyer organizations. Similarly, in auctions, goods and services are transacted based on the bids offered by various suppliers or buyers depending on the context, where the auctions may be real time auctions or non-real-time auctions. Both the procurement scenario and auction scenario rely on static data associated with the suppliers and buyers to manage buying decisions. However, buying decisions made based on the static data are not accurate, since they do not provide real-time information, and behavior of the organizations and users representing the organization at the time of decision making. Real-time information and behavior of the involved organizations and users representing the organizations enable informed decision making.

### BRIEF DESCRIPTION OF THE DRAWINGS

The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary high level architecture for sentiment evaluation of entities in procurement and auctions, according to an embodiment.

FIG. 2 is a block diagram illustrating a supplier profile for sentiment evaluation of entities in a procurement application, according to one embodiment;

FIG. 3 is a table illustrating calculation of weighted sentiment values in a procurement application, according to an embodiment.

FIG. 4 is a table illustrating calculation of weighted sentiment values in a procurement application, according to one embodiment.

FIG. 5 illustrates a user interface displaying sentiment values for entities supplier company and supplier user, according to one embodiment.

FIG. 6 illustrates a user interface for sentiment based searching for entities, according to one embodiment.

FIG. 7 is a flow diagram illustrating sentiment evaluation of entities in procurement and auctions, according to one embodiment.

FIG. 8 is a block diagram illustrating an exemplary computer system, according to an embodiment.

### DETAILED DESCRIPTION

Embodiments of techniques of computing system to evaluate sentiment of entities by processing data are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Procurement applications in procurement network enable managing financial data and transactions. The procurement applications set a standard process for procurement of goods and services. Suppliers can register in the procurement application by creating a supplier profile, and providing supplier associated data, answers to questionnaire, etc. Users representing the suppliers can also be registered in the procurement application. These users represent the suppliers during auctions. Similarly, buyer organizations and users representing buyer organizations can also be registered in the procurement application.

When a contract is generated in a procurement application, a past bidding practice of the buyers can have an influence in the generation of the current contract. Similarly, the type of contracts accepted by the suppliers in the past can have an influence in current contract. The contract is influenced based on a behavior or pattern of the buyers and the suppliers. Buyers often depend on the associations they make, and what they have learned about a specific supplier, which can influence buyer decision making. The behavior can be studied by sentiment analysis. Sentiment refers to subjective impressions such as attitude, emotions, opinions, etc. Sentiment analysis is the process of using natural language processing techniques, statistics or machine learning algorithms or methods to extract, identify, or characterize the sentiment content.

In sentiment analysis, subjective information is extracted from several sources from the internet, that provides insights about opinions on suppliers such as from reviews, financial results, rating on service, related recent news, tweets, comments, social networking site conversations, advertisements, etc. The subjective information from these sources is typically in an unstructured form referred to as unstructured data. Unstructured data captured from the sources of web are parsed and processed using natural language processing, text analysis, etc. Sentiment calculation is performed on the processed data to compute/evaluate sentiment value associated with the suppliers and buyers. Sentiment analysis provides valuable insight to the suppliers and buyers in making informed decisions.

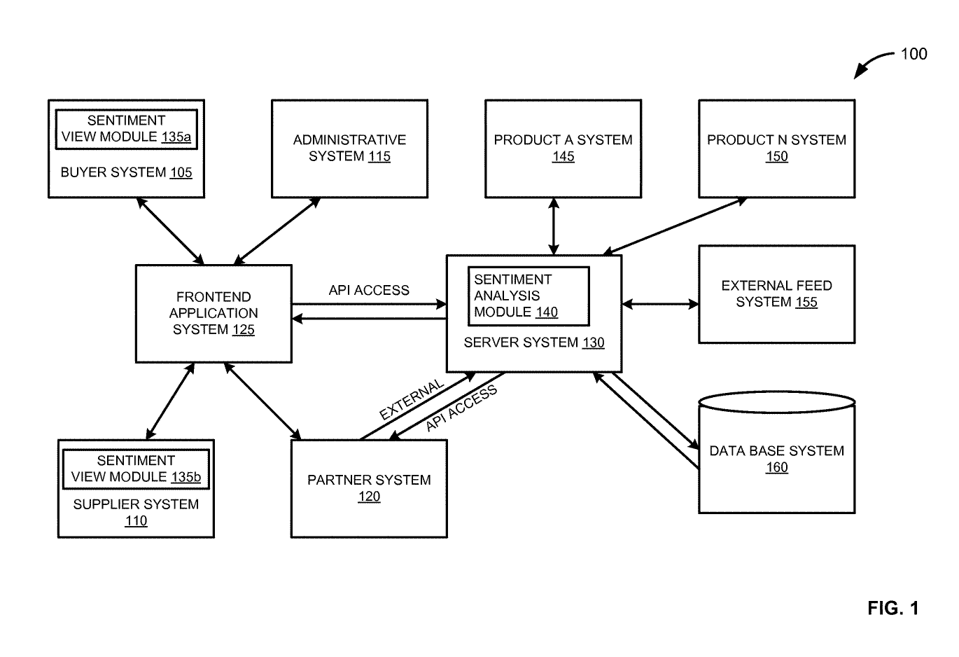

FIG. 1 is a block diagram illustrating exemplary high-level architecture 100 for sentiment evaluation of entities in procurement and auctions, according to one embodiment. FIG. 1 is shown containing a buyer system 105, supplier system 110, administrative system 115, and partner system 120 in communication with a frontend application system 125. Frontend application system 125 may be an enterprise system with an enterprise application such as procurement application, capable of integrating the various systems and products interacting with the frontend application system 125. The enterprise application in the frontend application system 125 may be implemented as a cloud application, on demand or on premise application. Depending on the type of implementation, interaction between the frontend application system 125 and the various systems and products is determined. Data from the various systems and products are received at the frontend application system 125 and sent to the server system 130 for processing. The processed data from the server system 130 is received at the frontend application system 125.

The communication between the frontend application system 125 and the server system 130 may be in the form of internal application programming interface (API) calls. An API is a set of routine, protocols and tools that defines functionalities of the enterprise application independent of implementation of the enterprise application. The API calls between the frontend application system 125 and the server system are internal to the enterprise and are referred to as internal API calls. Similarly, the API calls between the partner system 120 and the server system 130 are external to the enterprise and are referred to as external API calls. The API calls from the partner system 120 can be served as pay per request or pay per specific number of requests by the server system 130.

The buyer system 105 and the supplier system 110 have sentiment view modules 135a and 135b respectively, and the server system 130 has a sentiment analysis module 140. Sentiment view module 135a, sentiment view module 135b and sentiment analysis module 140 may be a combination of software program logic and a graphical user interface associated with the procurement application. Various other product systems such as product system A 145, product system N 150 and external feed system 155, interact with the server system 130. Product system A 145 and product system N 150 may be specialized enterprise systems with hardware capable of hosting and executing specialized enterprise software applications. External feed system 155 may be a specialized system with hardware capable of hosting and executing social networking applications. Partner system 120 may be a third-party system with hardware capable of hosting and executing third-party enterprise software applications. The buyer system 105 and the supplier system 110 may receive data from a buyer user and a supplier user. The buyer system 105 and the supplier system 110 may be client systems, where the client systems can be computing devices such as mobile phones, desktop or portable computers, tablet computers, etc.

When a supplier is registered in the procurement application by creating a supplier profile, and providing supplier associated data, answers for questionnaire, etc., data associated with the supplier is sent to the server system 130 via frontend application system 125. Based on the data sent by the supplier, a sentiment value for the supplier is calculated in the sentiment analysis module 140 in the server system 130. The computed/evaluated sentiment value for supplier can be displayed in the sentiment view module 135b in the supplier system 110. Similarly, individual sentiment values can be calculated for supplier users, suppliers, buyers and buyer users respectively in the sentiment analysis module 140. Supplier users may be users representing suppliers and buyer users may be users representing buyers. Calculated sentiment values can be stored in the database system 160. Database system 160 may be an in-memory database that primarily relies on main memory such as RAM (Random access memory) for processing and data storage.

Product system A 145 and product system N 150 may represent any enterprise product that enables collection of data about suppliers or buyers from various other data bases associated with the enterprise product, or various other web sources. The gathered data are sent to the server system 130, and the sentiment analysis module 140 in the server system 130 analyzes the data to calculate sentiment values for the suppliers or buyers. External feed system 155 enables collection of data feeds from tweets, social networking sites or any other source external to the enterprise. Calculated sentiment values are stored in the database system 160.

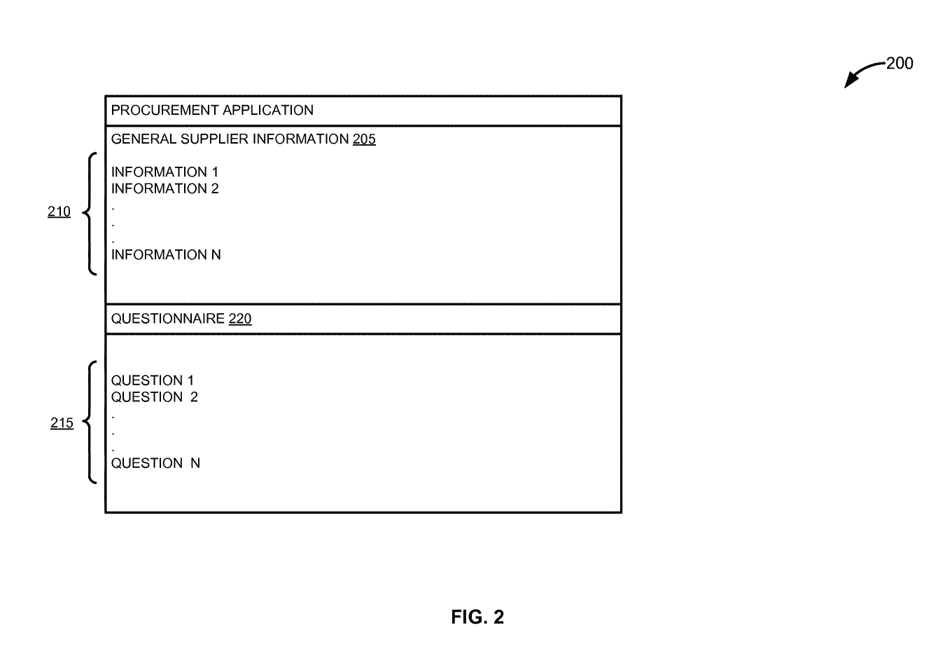

FIG. 2 is a block diagram illustrating a supplier profile 200 for sentiment evaluation of entities in a procurement application, according to one embodiment. In the example below, the supplier organizations ‘supplier A’ and ‘supplier B’, buyer organization ‘buyer A’, ‘supplier user A’, and ‘buyer user A’ are referred to individually as an entity. Supplier organization ‘supplier A’ and ‘supplier user A’ representing ‘supplier A’ are registered in the procurement application by creating a supplier profile. While registering, in ‘general supplier information’ section 205, ‘supplier A’ may provide the requested set of information 210 ‘information 1’ to ‘information N’. Similarly, ‘supplier A’ may also provide answers to the set of questions 215 in the ‘questionnaire’ section 220. ‘General supplier information’ section 205 and ‘questionnaire’ section 220 are merely exemplary. Many more sections may be provided to ‘supplier A’ in the procurement application. Sentiment analysis/evaluation is performed based on the information and answers provided in the ‘General supplier information’ section 205 and ‘questionnaire’ section 220, by mining the information and questionnaire answers to extract ‘keyword(s)’ with a negative, neutral or positive sentiment. Extracted ‘keyword(s)’ may be associated with a numeric value referred to as a sentiment indicator, and the numeric value may be associated with any standard scale or user-defined scale. For example, a scale of 31 10 to +10 can be associated with the extracted ‘keyword’.

Based on the sentiment of the extracted ‘keyword’ a relative numeric value is associated with the extracted ‘keyword’. If the extracted ‘keyword’ indicates a positive sentiment, a positive numeric value of sentiment indicator is associated from a scale. If the extracted ‘keyword’ indicates a neutral sentiment, a mid numeric value of sentiment indicator is associated from the scale. If the extracted ‘keyword’ indicates a negative sentiment, a negative numeric value of sentiment indicator is associated from the scale. For a ‘keyword’ ‘excellent’ a sentiment indicator of ‘+9’ can be associated, for a ‘keyword’ ‘poor future’ a sentiment indicator of ‘−8’ can be associated, for a ‘keyword’ ‘average growth’ a sentiment indicator of ‘0’ can be associated, etc. The sum of the individual sentiment indicators gives us a total sentiment indicator for ‘supplier A’ in the ‘general supplier information’ section 205. Similarly, a total sentiment indicator for ‘supplier A’ in the ‘questionnaire’ section 220 is calculated. Sum of the total sentiment indicator for ‘supplier A’ in the ‘general supplier information’ section 205, and the total sentiment indicator for ‘supplier A’ in the ‘questionnaire’ section 220, gives an overall sentiment indicator/sentiment indicator for ‘supplier A’.

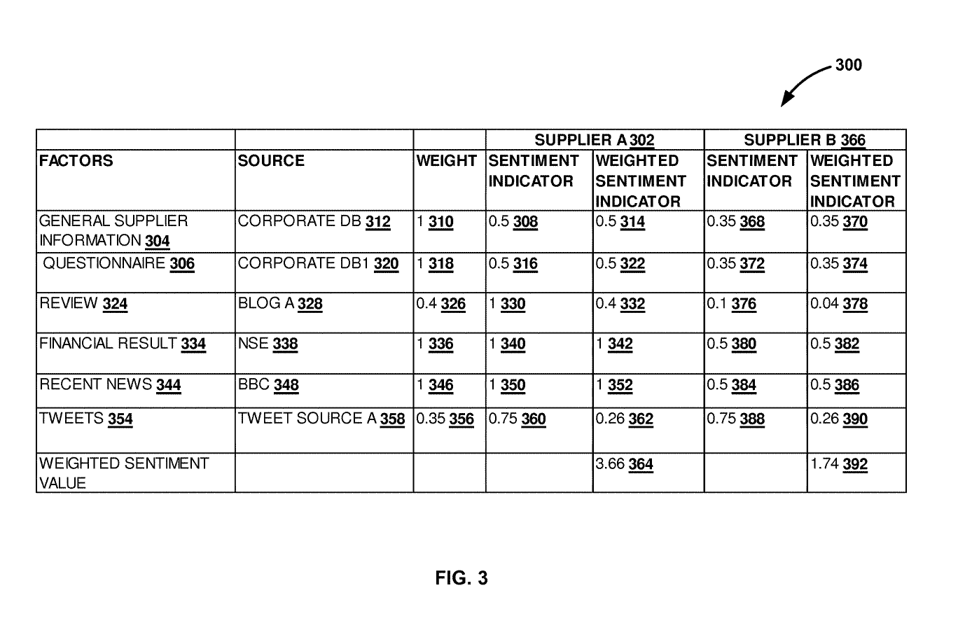

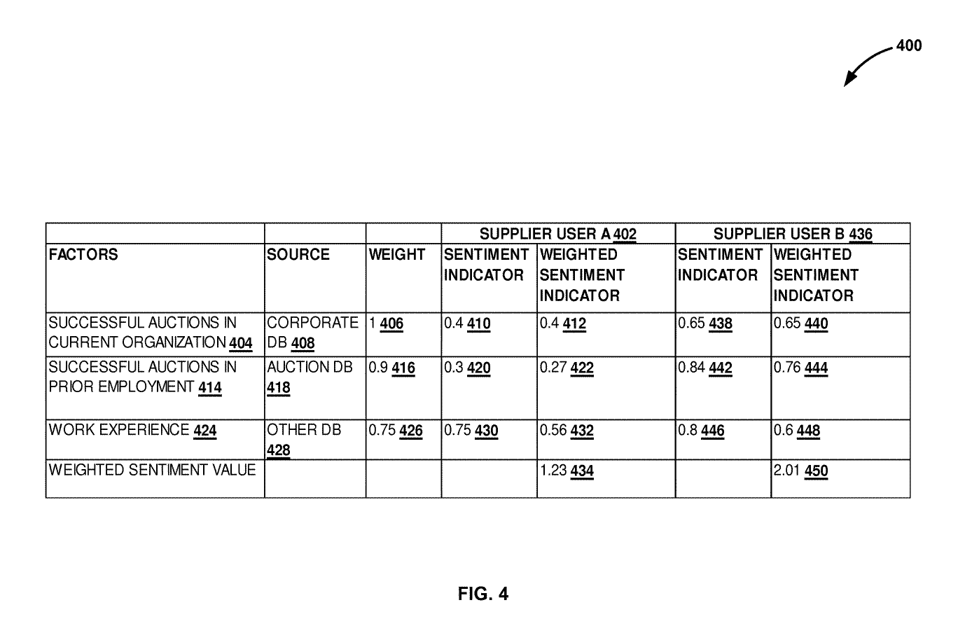

Consider an example, where supplier organization ‘supplier A’ and ‘supplier user A’ representing the supplier organization are registered in a procurement application by creating a supplier profile. Similarly, another supplier organization ‘supplier B’ and ‘supplier user B’ representing the other supplier organization are registered in the procurement application by creating another supplier profile. Buyer organization ‘buyer A’ and ‘buyer user A’ representing the buyer are registered in the procurement application by creating a buyer profile. When the buyer organization ‘buyer A’ intends to procure ‘product A’, a request is raised in the procurement application. Various suppliers registered in the procurement application bid their respective price quotation for the indicated quantity of ‘product A’. Sentiment analysis/evaluation of the supplier and buyer entities is explained below in FIG. 3 and FIG. 4.

FIG. 3 is a table illustrating calculation of weighted sentiment values 300 in a procurement application, according to one embodiment. Consider an example of calculation of weighted sentiment values of entities such as supplier organizations and supplier users. Entity ‘supplier A’ 302 registers with the procurement application by providing information and answers in factors ‘general supplier information’ 304 and ‘questionnaire’ 306. Factors ‘general supplier information’ 304 and ‘questionnaire’ 306 are internal to supplier organization and they are referred to as ‘internal factors’, and the ‘internal factors’ can be dynamically changed based on the changes made in the procurement application. ‘Keywords’ associated with a sentiment are extracted from the information provided in the factor ‘general supplier information’ 304, and a corresponding numeric value referred to as a sentiment indicator is associated with the individual extracted ‘keywords’. Sum of individual sentiment indicators of the ‘keywords’ is calculated as ‘0.5’ 308 for ‘supplier A’ 302 corresponding to the factor ‘general supplier information’ 304. A relative weight is associated with a source depending on the authenticity of the source, importance associated with the source, type of the source, etc. For example, for a reliable source such as a corporate database, a weight of ‘1’ can be associated, for a blog source a relatively less weight of ‘0.4’ may be associated, etc. A weight of ‘1’ 310 is associated with the source ‘corporate DB’ 312 corresponding to the factor ‘general supplier information’ 304. The product of weight ‘1’ 310 and the sentiment indicator ‘0.5’ 308 is the weighted sentiment indicator ‘0.5’ 314 of ‘supplier A’302. Similarly, a sentiment indicator is calculated as ‘0.5’ 316 for ‘supplier A’ 302 corresponding to the factor ‘questionnaire’ 306. A weight of ‘1’ 318 is associated with the source ‘corporate DB1’ 320 corresponding to the factor the ‘questionnaire’ 306. The product of weight ‘1’ 318 and the sentiment indicator ‘0.5’ 316 is the weighted sentiment indicator ‘0.5’ 322 of ‘supplier A’ 302.

Subjective information associated with the ‘supplier A’ 302 is dynamically extracted from several sources of web such as data feeds, tweets, comments, recent news, etc., other products, and used in calculation of sentiment value. The subjective factors are external to the supplier organization and they are referred to as ‘external factors’. The ‘external factors’ can be dynamically changed in real-time by adding new factors, and deleting or modifying existing factors. ‘Internal factors’ and ‘external factors’ may be user-defined. For a factor ‘review’ 324, a weight of ‘0.4’ 326 is associated with a source ‘blog A’ 328. Based on the sentiment of keywords such as ‘excellent’ and ‘good’ extracted from source ‘blog A’ 328, a sentiment indicator is calculated as ‘1’ 330. The product of weight ‘0.4’ 326 and the sentiment indicator ‘1’ 330 is the weighted sentiment indicator ‘0.4’ 332 for ‘supplier A’ 302 for the factor ‘review’ 324. For a factor ‘financial result’ 334, a weight of ‘1’ 336 is associated with a source ‘NSE’ 338, and a sentiment indicator is calculated as ‘1’ 340. The product of weight ‘1’ 336 and the sentiment indicator ‘1’ 340 is the weighted sentiment indicator ‘1’ 342 for ‘supplier A’ 302 corresponding to the factor ‘financial result’ 334.

For a factor ‘recent news’ 344, a weight of ‘1’ 346 is associated with a source ‘BBC’ 348, and a sentiment indicator is calculated as ‘1’ 350. The product of weight ‘1’ 346 and the sentiment indicator ‘1’ 350 is the weighted sentiment indicator ‘1’ 352 for the ‘supplier A’ 302 corresponding to the factor ‘recent news’ 344. For a factor ‘tweets’ 354, a weight of ‘0.35’ 356 is associated with a source ‘tweet source A’ 358, and a sentiment indicator is calculated as ‘0.75’ 360. The product of weight ‘0.35’ 356 and the sentiment indicator is ‘0.75’ 360 is the weighted sentiment indicator ‘0.26’ 362 for ‘supplier A’ 302 corresponding to the factor ‘tweets’ 354. Sum of weighted sentiment indicators 314, 322, 332, 342, 352 and 362 is the weighted sentiment value ‘3.66’ 364 of ‘supplier A’ 302. The weighted sentiment value can be displayed in the sentiment view module in the supplier system.

In a similar way, the weighted value of factors is computed/evaluated for entity ‘supplier B’ 366 registered with the procurement application. A sentiment indicator ‘0.35’ 368 is calculated for ‘supplier B’ 366 for the factor ‘general supplier information’ 304. The product of weight ‘1’ 310 and the sentiment indicator ‘0.35’ 368 is the weighted sentiment indicator ‘0.35’ 370 for ‘supplier B’ 366 corresponding to the factor ‘general supplier information 304. A sentiment indicator ‘0.35’ 372 is calculated for ‘supplier B’ 366 for the factor ‘questionnaire’ 306. The product of weight ‘1’ 318 and the sentiment indicator ‘0.35’ 372 is the weighted sentiment indicator ‘0.35’ 374 for ‘supplier B’ 366 corresponding to the factor ‘questionnaire’ 306. For a factor ‘review’ 324, a sentiment indicator is calculated as ‘0.1’ 376. The product of weight ‘0.4’ 326 and the sentiment indicator ‘0.1’ 376 is the weighted sentiment indicator ‘0.04’ 378 for ‘supplier B’ 366 corresponding to the factor ‘review’ 324.

For a factor ‘financial results’ 334, a sentiment indicator is calculated as ‘0.5’ 380. The product of weight ‘1’ 336 and the sentiment indicator ‘0.5’ 380 is the weighted sentiment indicator ‘0.5’ 382 corresponding to the factor ‘financial results’ 334. For a factor ‘recent news’ 344, a sentiment indicator is calculated as ‘0.5’ 384. The product of weight ‘1’ 346 and the sentiment indicator ‘0.5’ 384 is the weighted sentiment indicator ‘0.5’ 386 for ‘supplier B’ 366 corresponding to the factor ‘recent news’ 344. For a factor ‘tweets’ 354, a sentiment indicator is calculated as ‘0.75’ 388. The product of weight ‘0.35’ 356 and the sentiment indicator ‘0.75’ 388 is the weighted value ‘0.26’ 390 for ‘supplier B’ 366 corresponding to the factor ‘tweets’ 354. Sum of weighted sentiment indicators 370, 374, 378, 382, 386 and 390 is the weighted sentiment value ‘1.74’ 392 of ‘supplier B’ 366. The weighted sentiment value can be displayed in the sentiment view module in the supplier system.

The calculation of weighted sentiment value of an entity may be represented in an equation as shown below:
Weighted sentiment value of an entity=Σ((weight of source 1 * sentiment indicator of entity corresponding to source 1)+(weight of source2 * sentiment indicator of entity corresponding to source 2) + . . . (weight of source N * sentiment indicator of entity corresponding to source N) where, weight of a source may be a user-defined weight, and the sentiment indicator of entity corresponding to the source is mathematically computed/evaluated in one of the following ways such as sum of individual sentiment indicator of keywords, percentage of a parameter, etc.

The weighted sentiment value can be mapped to a sentiment representation such as free form text, a graphical representation, etc. A mapping between weighted sentiment value and a sentiment representation can be user-defined and may be changed dynamically based on the context, and stored in a database system. For example, a weighted sum of sentiment value ranging between >=4 and <=6 is mapped to a free form text “Strong market presence and highly recommended”, a weighted sentiment value ranging between >=2 and <4 is mapped to a free form text “average market presence and recommended”, and a weighted sentiment value ranging between >=0 and <2 is mapped to a free form text “below average market presence and not recommended”. The weighted sentiment value ‘3.66’ 364 of ‘supplier A’ 302 is mapped to a sentiment data “average market presence and recommended”. The weighted sentiment value ‘1.74’ 392 of ‘supplier B’ 366 is mapped to a sentiment data “below average market presence and not recommended”. The mapped values are displayed in the sentiment view module of “buyer system”. Buyer may be able to decide that ‘supplier A’ 364 has a strong market presence and is recommended over ‘supplier B’ 366 based on the sentiment evaluation. In one embodiment, if an API request including a parameter ‘supplier=supplier A’ is received from a partner system, the API request is authenticated and validated to determine if the API request is a paid request. When the API request is validated, a response to the API request is provided as ‘average market presence and recommended’. An API request may include any number of parameters.

FIG. 4 is a table illustrating calculation of weighted sentiment values 400 in a procurement application, according to one embodiment. In one embodiment, for entities ‘supplier user A’ and ‘supplier user B’ registered with the procurement application, sentiment evaluation is performed. Various factors associated with the supplier users are profile information, designation, familiarity with number of auctions, number of successful bids, relevant experience, etc. The factors and the sources associated with the factors can be dynamically changed in real-time. Information associated with these factors, mined and extracted from various source enable calculation of sentiment values for the supplier users. A weight is associated with a source depending on the authenticity of the source, importance associated with the source, type of the source, etc. Consider an entity ‘supplier user A’ 402, for a factor ‘successful auctions in current organization’ 404, a weight of ‘1’ 406 is associated with a source ‘corporate DB’ 408. ‘Supplier user A’ 402 was successful in 40 auctions out of 100 auctions in the current organization. Accordingly, a sentiment indicator is calculated as 40/100=‘0.4’ 410. The product of weight ‘1’ 406 and the sentiment indicator ‘0.4’ 410 is the weighted sentiment indicator ‘0.4’ 412 of ‘supplier user A’ 402 for the factor ‘successful auctions in current organization’ 404.

For the factor ‘successful auctions in prior employment’ 414, a weight of ‘0.9’ 416 is associated with a source ‘auction DB’ 418. ‘Supplier user A’ 402 was successful in 150 auctions out of 500 auctions in the prior employment. Accordingly, a sentiment indicator is calculated as 150/500=‘0.3’ 420. The product of weight ‘0.9’ 416 and the sentiment indicator ‘0.3’ 420 is the weighted sentiment indicator ‘0.27’ 422 corresponding to the factor ‘successful auctions in prior employment’ 414. For the factor ‘work experience’ 424, a weight of ‘0.75’ 426 is associated with a source ‘other DB’ 428. ‘Supplier user A’ 402 has an experience of 12 years and accordingly sentiment indicator is ‘0.75’ 430. The product of weight ‘0.75’ 426 and the sentiment indicator ‘0.75’ 430 is the weighted sentiment indicator ‘0.56’ 432 of ‘supplier user A’ 402 for the factor ‘work experience’ 424. Sum of weighted sentiment indicators 412, 422 and 432 is the weighted sentiment value ‘1.23’ 434 of ‘supplier user A’ 402.

Similarly, for the factor ‘successful auctions in current organization’ 404, ‘supplier user B’ 436 was successful in 65 auctions out of 100 auctions in the current organization. Accordingly, a sentiment indicator is calculated as 65/100=‘0.65’ 438. The product of weight ‘1’ 406 and the sentiment indicator ‘0.65’ 438 is the weighted sentiment indicator ‘0.65’ 440 for ‘supplier user B’ 436 corresponding to the factor ‘successful auctions in current organization’ 404. For the factor ‘successful auctions in prior employment’ 414, ‘supplier user B’ 436 was successful in 295 auctions out of 350 auctions in the prior employment. Accordingly, a sentiment indicator is calculated as 295/350=‘0.84’ 442. The product of weight ‘0.9’ 416 and the sentiment indicator ‘0.84’ 442 is the weighted sentiment indicator ‘0.76’ 444 for ‘supplier user B’ 436 corresponding to the factor ‘successful auctions in prior employment’ 414. For the factor ‘work experience’ 424, ‘supplier user B’ 436 has an experience of 14 years, and accordingly a sentiment indicator is calculated as ‘0.8’ 446. The product of weight ‘0.75’ 426 and the sentiment indicator value ‘0.8’ 446 is the weighted sentiment indicator ‘0.6’ 448 corresponding to the factor ‘work experience’ 424. Sum of weighted sentiment indicators 440, 444 and 448 is the weighted sentiment value ‘2.01’ 450 of ‘supplier user B’ 436.

The weighted sentiment values can be mapped to a sentiment representation such as free form text, a graphical representation, etc. For example, a weighted sentiment value ranging between >=1 and <=2 is mapped to a free form text “average bidder”, and a weighted sentiment value ranging between >2 and <=3 is mapped to a free form text “aggressive bidder”. The weighted sentiment value of ‘supplier user A’ ‘1.23’ 434 is mapped to a sentiment representation “average bidder”. The weighted sentiment value of ‘supplier user B’‘ 2.01’ 450 is mapped to a sentiment representation “aggressive bidder”. The mapped values are displayed in the sentiment view module of “buyer system”. The buyer can make a decision that ‘supplier user B’ 436 is an aggressive bidder, in comparison to the ‘supplier user A’ 402.

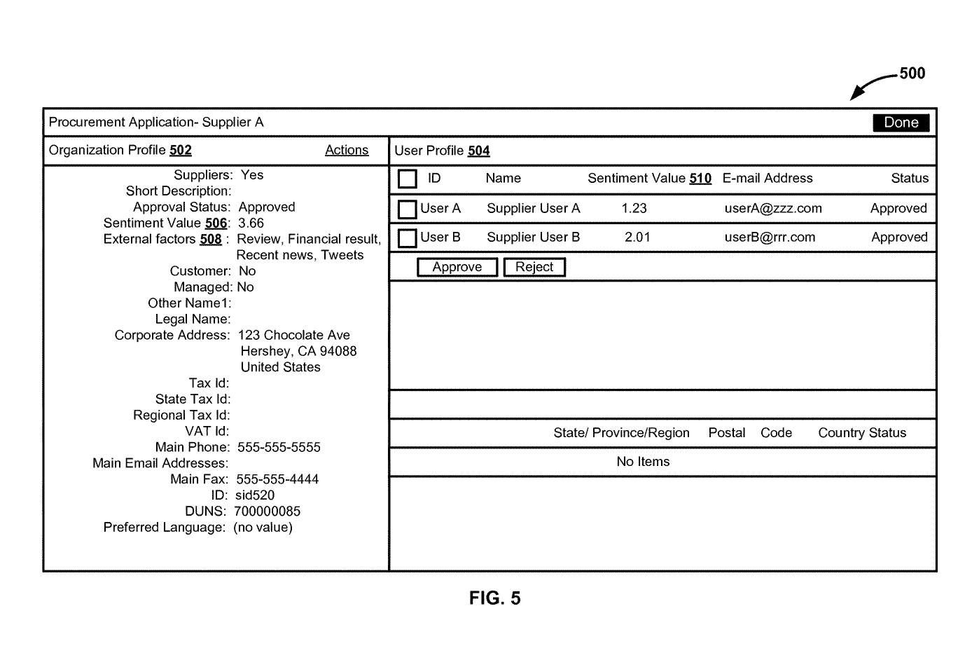

FIG. 5 illustrates a user interface 500 displaying sentiment values for entities supplier organization and supplier user, according to one embodiment. ‘General supplier information’, ‘questionnaire’, etc., provided while registering a supplier organization ‘supplier A’ is displayed in organization profile section 502. Similarly, registration information provided by supplier users ‘supplier user A’ and ‘supplier user B’ representing supplier organization ‘supplier A’ is displayed in the ‘user profile’ section 504. In the organization profile section 502, a sentiment value ‘3.66’ calculated for the ‘supplier A’ as explained in FIG. 3 is displayed in field ‘sentiment value’506. Various factors such as ‘review’, ‘financial result’, ‘recent news’, ‘tweets’, etc., contributing to the sentiment value of ‘supplier A’ can be displayed as shown in the field ‘external factors’ 508. In the ‘user profile’ section 504, a sentiment value ‘1.23’ calculated for ‘supplier user A’ as shown in FIG. 4 is displayed in field ‘sentiment value’ 510, and a sentiment value ‘2.01’ calculated for ‘supplier user B’ is displayed in field ‘sentiment value’ 510.

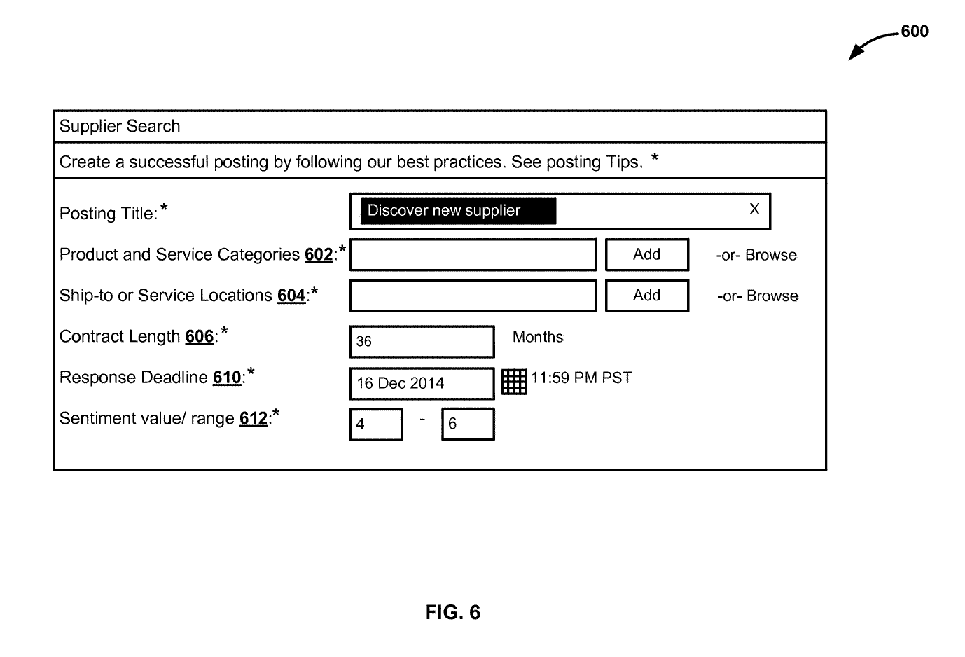

FIG. 6 illustrates a user interface 600 for sentiment based searching for entities, according to one embodiment. Buyers can search supplier organizations based on a sentiment value or a sentiment range. Buyers can provide various search parameters such as product and service categories 602, ship to or service location 604, contract length 606, response deadline 610, etc., to search for specific supplier organizations. In addition to these search parameters, a range of sentiment values can be provided in the search criteria ‘sentiment value/range’612 as ‘4’ to ‘6’. The supplier organizations satisfying the specified search criteria are filtered and returned for display in the user interface 600.

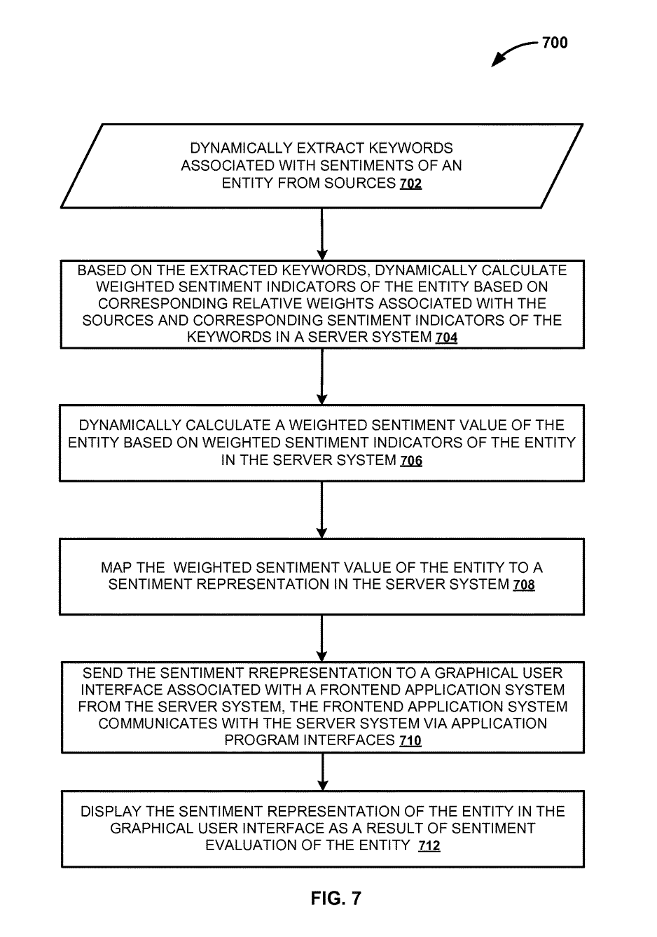

FIG. 7 is a flow diagram illustrating sentiment evaluation of entities in procurement and auctions 700, according to one embodiment. At 702, keywords associated with sentiments of an entity are dynamically extracted from sources. At 704, based on the extracted keywords, weighted sentiment indicators of the entity are dynamically calculated based on corresponding relative weights associated with the sources and corresponding sentiment indicators of the keywords in a server system. At 706, a weighted sentiment value of the entity is dynamically calculated based on weighted sentiment indicators of the entity in the server system. At 708, the weighted sentiment value of the entity is mapped to a sentiment representation in the server system. At 710, the sentiment representation is sent to a graphical user interface associated with a frontend application system from the server system. The frontend application system communicates with the server system via application program interfaces. At 712, the sentiment representation of the entity is displayed in the graphical user interface as a result of sentiment evaluation of the entity.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

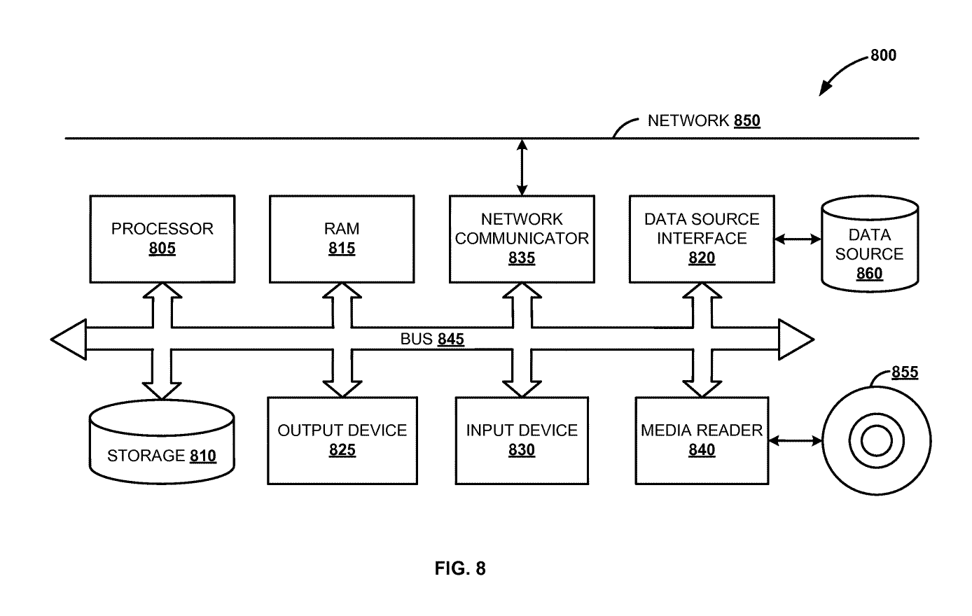

FIG. 8 is a block diagram illustrating an exemplary computer system 800, according to an embodiment. The computer system 800 includes a processor 805 that executes software instructions or code stored on a computer readable storage medium 855 to perform the above-illustrated methods. The processor 805 can include a plurality of cores. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. According to some embodiments, such as some in-memory computing system embodiments, the RAM 815 can have sufficient storage capacity to store much of the data required for processing in the RAM 815 instead of in the storage 810. In some embodiments, all of the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible within the scope, as those skilled in the relevant art will recognize. These modifications can be made in light of the above detailed description.

What is claimed is:

1. A computer system to evaluate sentiment of entities by processing data, comprising:
a computer memory to store program code; and
a processor to execute the program code to:
dynamically extract keywords associated with sentiments of an entity from sources to a server system;
based on the extracted keywords, dynamically calculate a weighted sentiment value of the entity based on weighted sentiment indicators of the entity in the server system;
map the weighted sentiment value of the entity to a sentiment representation in the server system; and
send the weighted sentiment value and the sentiment representation to a database system.

2. The system of claim 1, wherein the weighted sentiment indicators of the entity are calculated based on corresponding relative weights associated with the sources and corresponding sentiment indicators of the keywords in the server system.

3. The system of claim 1, further comprising instructions which when executed by the computer further causes the computer to:
dynamically calculate a weighted sentiment value of a new entity based on weighted sentiment indicators of the new entity in the server system;
map the weighted sentiment value of the new entity to a new sentiment representation in the server system; and
send the sentiment representation of the entity and the new sentiment representation of the new entity to a graphical user interface for comparison of the entity and the new entity.

4. The system of claim 1, wherein the weighted sentiment indicators of the entity are calculated based on corresponding relative weights associated with the sources and corresponding sentiment indicators mathematically computed by the server system.

5. The system of claim 1, wherein the sentiment representation is a user-defined representation and the corresponding sentiment indicators of the keywords are based on a user-defined scale.

6. The system of claim 1, further comprising instructions which when executed by the computer further causes the computer to:
receive a sentiment representation as search parameter; and
return entities matching the search parameter in a graphical user interface.

7. A computer-implemented method of evaluating sentiment of entities by processing data, the method comprising:
dynamically extract keywords associated with sentiments of an entity from sources to a server system;
based on the extracted keywords, dynamically calculate a weighted sentiment value of the entity based on weighted sentiment indicators of the entity in the server system;
map the weighted sentiment value of the entity to a sentiment representation in the server system; and
send the sentiment representation to a graphical user interface associated with a frontend application system from the server system, wherein the frontend application system communicates with the server system via application program interfaces.

8. The method of claim 7, wherein the weighted sentiment indicators of the entity are calculated based on corresponding relative weights associated with the sources and corresponding sentiment indicators of the keywords in the server system.

9. The method of claim 7, further comprising instructions which when executed by the computer further causes the computer to:
dynamically calculate a weighted sentiment value of a new entity based on weighted sentiment indicators of the new entity in the server system;
map the weighted sentiment value of the new entity to a new sentiment representation in the server system; and
send the sentiment representation of the entity and the new sentiment representation of the new entity to the graphical user interface for comparison of the entity and the new entity.

10. The method of claim 7, wherein the weighted sentiment indicators of the entity are calculated based on corresponding relative weights associated with the sources and corresponding sentiment indicators mathematically computed by the server system.

11. The method of claim 7, wherein the sentiment representation is a user-defined representation and the corresponding sentiment indicators of the keywords are based on a user-defined scale.

12. The method of claim 7, further comprising instructions which when executed by the computer further causes the computer to:
receive a sentiment representation as search parameter; and
return entities matching the search parameter in the graphical user interface.

13. The method of claim 7, further comprising instructions which when executed by the computer further causes the computer to:
display the sentiment representation of the entity as a recommendation in the graphical user interface.

14. A non-transitory computer-readable medium to store instructions, which when executed by a computer, cause the computer to perform operations comprising:
dynamically extract keywords associated with sentiments of an entity from sources to a server system;
based on the extracted keywords, dynamically calculate a weighted sentiment value of the entity based on weighted sentiment indicators of the entity in the server system;
map the weighted sentiment value of the entity to a sentiment representation in the server system; and
send the weighted sentiment value and the sentiment representation to a database system.

15. The computer-readable medium of claim 14, wherein the weighted sentiment indicators of the entity are calculated based on corresponding relative weights associated with the sources and corresponding sentiment indicators of the keywords in the server system.

16. The computer-readable medium of claim 14, to store instructions, which when executed by the computer, cause the computer to perform operations:
dynamically calculate a weighted sentiment value of a new entity based on weighted sentiment indicators of the new entity in the server system;
map the weighted sentiment value of the new entity to a new sentiment representation in the server system; and
send the sentiment representation of the entity and the new sentiment representation of the new entity to a graphical user interface for comparison of the entity and the new entity.

17. The computer-readable medium of claim 14, to store instructions, which when executed by the computer, cause the computer to perform operations:
calculate the weighted sentiment indicators of the entity based on corresponding relative weights associated with the sources and a corresponding sentiment indicators mathematically computed by the server system.

18. The computer-readable medium of claim 14, wherein the sentiment representation is a user-defined representation and the corresponding sentiment indicators of the keywords are based on a user-defined scale.

19. The computer-readable medium of claim 14, to store instructions, which when executed by the computer, cause the computer to perform operations:
receive a sentiment representation as search parameter in a graphical user interface; and
display entities matching the search parameter in the graphical user interface.

20. The computer-readable medium of claim 19, to store instructions, which when executed by the computer, cause the computer to perform operations:
display the sentiment representation of the entity as a recommendation in the graphical user interface.
